(19) United States
(12) Patent Application Publication
(10) Pub. No.: US 2012/0243607 A1
(43) Pub. Date: Sep. 27, 2012

(54) METHOD FOR IMAGE CODING AND DECODING

(75) Inventors: Fabien Racape, Rennes (FR); Dominique Thoreau, Cesson Sevigne Cedex (FR); Jerome Vieron, Paris (FR); Edouard Francois, Bourg des Comptes (FR)

(73) Assignee: Thomson Licensing, Issy-les-Moulineaux (FR)

(21) Appl. No.: 13/379,067

(22) PCT Filed: Jun. 21, 2010
(86) PCT No.: PCT/EP2010/058738

§ 371 Date: Jun. 12, 2012

(30) Foreign Application Priority Data
Jun. 22, 2009 (EP) 09305583.8

(51) Int. Cl. H04N 7/32

(52) U.S. Cl. 375/240.12; 375/E07.243

(57) ABSTRACT

A method for coding an image divided into sub-regions is described. The coding method comprises the following steps:
extracting from the image sub-regions representative of other sub-regions of the image,
coding the sub-regions representative of other sub-regions at a first quality, and
coding the other sub-regions at a second quality strictly lower than the first quality.

### 1. SCOPE OF THE INVENTION

The invention relates to the general domain of image coding. The invention relates to a method for coding and a method for decoding images.

### 2. PRIOR ART

It is known in the art to efficiently code a sequence of images to use a coding method in accordance with the standard H.264. This standard H.264 is notably defined in the ISO/IEC 14496-10 document entitled “Information technology—Coding of audio-visual objects—Part 10: Advanced Video Coding” published 15/08/2006. However, such a coding method provokes nevertheless artefacts particularly in the textured regions of images.

### 3. SUMMARY OF THE INVENTION

The purpose of the invention is to overcome at least one of the disadvantages of the prior art. Advantageously the invention enables textured regions of images to be coded more efficiently, i.e. with a better level of quality at constant bitrate or at a lower bitrate at a given level of quality. For this purpose regions of an image, also called patches, to be coded are identified and coded in a stream F at a quality greater than other patches of the image to be coded. These patches coded at a greater quality are then used by the decoding method to enrich the texture of patches coded at a lower quality. The coding method according to the invention enables a better distribution of information in the stream F in terms of perceptual redundancy.

### 4. LIST OF FIGURES

The invention will be better understood and illustrated by means of embodiments and advantageous implementations, by no means limiting, with reference to the figures in the appendix, wherein:

FIG. 1 shows a method for coding and a method for decoding according to the invention,

FIG. 2 shows a step of extraction of the coding method according to a first embodiment of the invention,

FIG. 3 shows a variant of this first embodiment,

FIG. 4 shows a step of extraction of the coding method according to a second embodiment of the invention,

FIG. 5 shows a coding device according to the invention, and

FIG. 6 shows a decoding device according to the invention.

### 5. DETAILED DESCRIPTION OF THE INVENTION

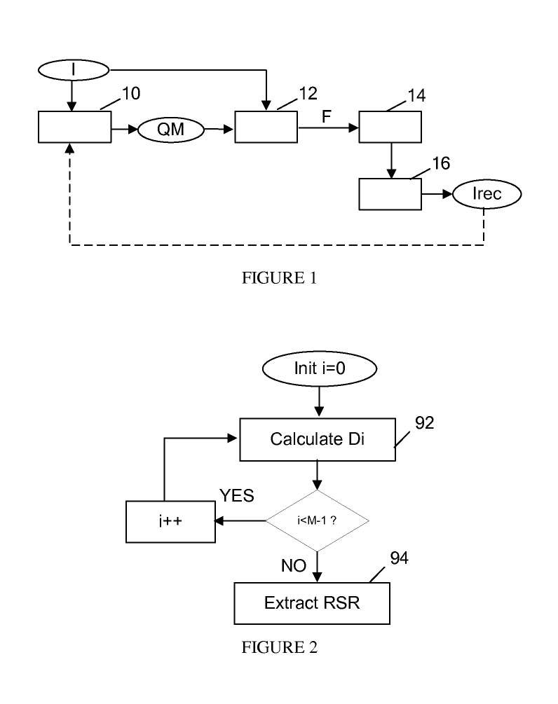

The invention relates to a method for coding a source image I described in connection with FIG. 1. The method comprises a step 10 of Representative Sub-Regions (RSR) extraction and a step 12 of encoding.

During a step 10, Representative Sub-Regions (RSR) representative of the rest of the source image, i.e. having a strong redundancy with the rest of the source image, are extracted from the source image I to be coded. Hereafter, the source image is simply referred to as the image. The step of extraction is based on the evaluation of the redundancy between a given sub-region and the rest of the image. When a given sub-region has a high redundancy with a high number of sub-regions of the image, this sub-region is declared to be an RSR and is placed in a “dictionary”.

According to a first embodiment described with reference to FIG. 2, the RSR sub-regions are extracted a priori, i.e. the operations and/or metrics used in the choice of RSR sub-regions do not take account of the exact process of redundancy exploitation that is implemented at the decoder. Hence, various solutions are possible to extract an RSR sub-region as the operations are not symmetrical with those implemented at the decoder. The set {SRᵢ}_{i∈{0;M-1}} of possible sub-regions of the image are defined as being a set of sub-regions forming a partition of the image. In other words, the image I is partitioned into M sub-regions. A sub-region is for example a block or a zone of any size or shape.

During a step 92, for each sub-region of the set of possible sub-regions {Srᵢ}_{i∈{0;M-1}} of the image is calculated a metric Di between SRi and the rest of the image. The metric in question enables the resemblance of a sub-region with another sub-region or with other sub-regions to be characterized. The metric is for example the mutual information in the mathematical sense of the term or a distortion such as a SAD (Sum of Absolute Differences) or an SSE (Sum of Squared Differences). The Mutual Information represents a form of conditional entropy calculation. According to another variant, the metric is a measurement of the phase correlation. For example

$$Di = {\sum }_{{SR}_{j} ∈ I \backslash \{ {SR}_{i} \}} sad ( {SR}_{i} ; {SR}_{j} ) ,$$

where sad(SRi;SRj) is the SAD calculated between the Sri region and the SRj region.

During a step 94, the sub-region SRj that has a maximum metric value Dj in the case where the metric is mutual information (respectively minimum in the case where the metric is a distortion) or the N sub-regions SRj that have the highest metric values in the case where the metric is mutual information (respectively the lowest in the case where the metric is a distortion) is kept as an RSR sub-region when there is a desire to extract the N RSR sub-regions most representative of the image. If the metric Di is the Mutual Information in the mathematical sense of the term or a phase correlation measurement, the N sub-regions SRj that have the highest metric values are kept as RSR sub-regions. If on the contrary the metric is a distortion, the N sub-regions SRj that have the lowest metric values are kept as RSR sub-regions.

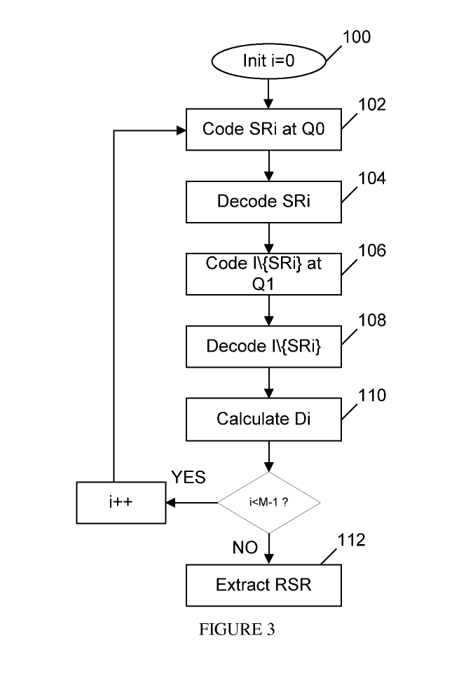

According to a variant of this first embodiment described in reference to FIG. 3, the following steps are carried out for the set of M possible sub-regions SRi of the image:
coding 102 SRi at a given quality Q0,
decoding 104 SRi,
coding 106 the rest of the image, i.e. the other sub-regions I\{SRi}, at a given quality Q1 (Q1<Q0),
decoding 108 the rest of the image, and
calculating 110 a metric Di between SRi decoded at Q0 and the rest of the image decoded at Q1.

The rest of the image I\{SRi} thus corresponds to the other sub-regions of the image.

During a step of initialisation 100, the index i is reset to zero: i=0.

During a step 102, the region SRi is coded at the quality Q0. The region SRi is for example coded in accordance with the standard H.264 or MPEG-2. However the invention is in no way limited by the coding method implemented in step 102. Thus according to an embodiment variant the region SRi is coded in accordance with the standard M-JPEG or JPEG2000. According to a particular embodiment, the region SRi is a block of pixels. The coding step 102 comprises the determination of a prediction block. For example, the prediction block is determined from a block spatially neighbouring the region SRi (mode INTRA), for example by linear combination of such blocks or of pixels of such blocks or of blocks of other images (mode INTER). The prediction block is then extracted from the region SRi, for example by subtraction pixel by pixel with or without weighting. The residue block thus obtained is transformed for example by a DCT (Discrete Cosine Transform) then quantized with a quantization step QPmin into a block of coefficients. The transform can be applied successively to several sub-blocks of the residue block. This is notably the case if the sub-region SRi is a macroblock of size 16×16 and if the DCT transform is an 8×8 transform. This coding step 102 does not require the implementation of an entropy coding step.

During a step 104, the region SRi is decoded. For this purpose, an inverse quantization is applied to the block of coefficients obtained in step 102 followed by an inverse transform, for example IDCT (Inverse Discrete Cosine Transform), to obtain a decoded residue block. This decoded residue block is then merged with the prediction block, for example by addition pixel by pixel with or without weighting. This decoding step 104 does not require the implementation of an entropy decoding step except if the coding step 102 itself comprises the entropy coding of the block of coefficients.

During a step 106, the rest of the image, i.e. I\{SRi}, is coded at a given quality Q1 where Q1<Q0. The same coding method as that used in step 104 to code the region SRi is used to code the rest of the image. As a simple example, the rest of the image is divided into blocks in the case where the coding method used in step 104 requires it. The coding step 106 comprises the determination of a prediction block for each block of the rest of the image to be coded. For example, the prediction block is determined from a block spatially neighbouring the block to be coded (mode INTRA), for example by linear combination of such blocks or of certain pixels of such blocks or of blocks of other images (mode INTER). The prediction block is then extracted from the block to be coded, for example by subtraction pixel by pixel with or without weighting. The residue block thus obtained is transformed for example by a DCT (Discrete Cosine Transform) then quantized with a quantization step QPmax>QPmin into a block of coefficients. The transform can be applied successively to several sub-blocks of the residue block. This is notably the case if the residue block is of size 16×16 and if the DCT transform is an 8×8 transform. This coding step does not require the implementation of an entropy coding step.

During a step 108, the rest of the image is decoded. Each block of the rest of the image is decoded in the case where a coding method per block was used in step 106. For this purpose, for each block to be decoded, an inverse quantization then an inverse transform, for example an IDCT (Inverse Discrete Cosine Transform) is applied to the corresponding block of coefficients obtained in step 106, to obtain a decoded residue block. This decoded residue block is then merged with the prediction block, for example by addition pixel by pixel with or without weighting. This decoding step does not require the implementation of an entropy decoding step except if the coding step itself comprises the entropy coding of blocks of coefficients.

During a step 110 a metric Di is calculated between SRi decoded at Q0 and the rest of the image decoded at Q1. The metric in question is for example the mutual information in the mathematical sense of the term or a distortion such as a SAD (Sum of Absolute Differences) or an SSE (Sum of Squared Differences). The Mutual Information represents a form of conditional entropy calculation. According to another variant, the metric is a measurement of the phase correlation.

If for the totality of the regions SRi of the set {SRᵢ}_{i∈{0;M-1}} a metric Di was calculated according to steps 102 to 110 then the method continues to step 112, if not the method repeats the step 102 with an index i incremented by 1. During a step 112, one keeps as sub-region RSR, i.e. one extracts from the set {SRᵢ}_{i∈{0;M-1}} of M possible sub-regions, the sub-region SRj that has a maximum metric value Dj in the case where the metric is mutual information or the phase correlation (respectively minimum in the case where the metric is a distortion) or the N sub-regions SRj that have the highest metric values in the case where the metric is mutual information or the phase correlation (respectively the lowest in the case where the metric is a distortion).

According to another variant, the step 102, comprises the quantization with a quantization step QPmin of the region SRi.

The step 104 comprises the inverse quantization of the region SRi. Step 106 comprises the quantization of the rest of the image with a quantization step QPmax>QPmin. In fact, the rest of the image is quantized more superficially, i.e. coded at a lower quality.

Step 108 comprises the inverse quantization of the rest of the image.

The other steps are identical to those of the first variant of this second embodiment.

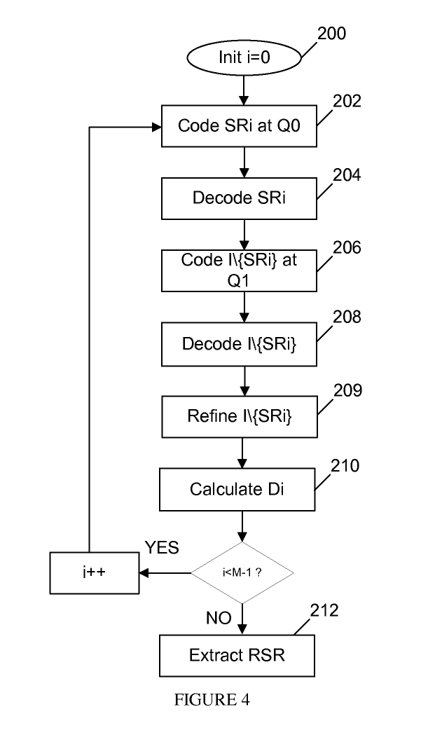

According to a second embodiment described with reference to FIG. 4, the RSR sub-regions are extracted a posteriori, i.e. the operations and/or metrics used in the choice of RSR sub-regions take account of the exact process of redundancy exploitation that is implemented at the decoder. According to this second embodiment, the following steps are carried out for the set of M possible SRi sub-regions of the image:
coding 202 SRi at a given quality Q0,
decoding 204 SRi,
coding 206 the rest of the image I\{SRi}, i.e. the other sub-regions, at a given quality Q1 (Q1<Q0),
decoding 208 the rest of the image, i.e. the other sub-regions,
refining 209 the texture of regions of the rest of the image and exploiting the SRi texture at the quality Q0, and
calculating 210 a metric Di between the refined image and its reference version, i.e. the source image.

Refining a texture means improving its quality, i.e. to render it closer to the texture that it had in the source image, or in other words increase the details.

During a step of initialisation 200, the index i is reset to zero: i=0.

During a step 202, the region SRi is coded at the quality Q0. The region SRi is for example coded in accordance with the standard H.264 or MPEG-2. However the invention is in no way limited by the coding method implemented in step 202. Thus according to an embodiment variant the region SRi is coded in accordance with the standard M-JPEG or JPEG2000. According to a particular embodiment, the region SRi is a block of pixels. The coding step 202 comprises the determination of a prediction block. For example, the prediction block is determined from a block spatially neighbouring the block to be coded (mode INTRA), for example by linear combination of such blocks or of certain pixels of such blocks or of blocks of other images (mode INTER). The prediction block is then extracted from the region SRi, for example by subtraction pixel by pixel with or without weighting. The residue block thus obtained is transformed for example by a DCT (Discrete Cosine Transform) then quantized with a quantization step QPmin into a block of coefficients. The transform can be applied successively to several sub-blocks of the residue block. The transform can be applied successively to several sub-blocks of the residue block. This is notably the case if the sub-region SRi is a macroblock of size 16×16 and if the DCT transform is an 8×8 transform. This coding step 202 does not require the implementation of an entropy coding step.

During a step 204, the region SRi is decoded. For this purpose, an inverse quantization is applied to the block of coefficients obtained in step 202 followed by an inverse transform, for example IDCT (Inverse Discrete Cosine Transform), to obtain a decoded residue block. This decoded residue block is then merged with the prediction block, for example by addition pixel by pixel with or without weighting. This decoding step 204 does not require the implementation of an entropy decoding step except if the coding step 202 itself comprises the entropy coding of the block of coefficients.

During a step 206, the rest of the image, i.e. I\{SRi} is coded at a given quality Q1 where Q1<Q0. The same coding method as that used in step 204 to code the region SRi is used to code the rest of the image. As a simple example, the rest of the image is divided into blocks in the case where the coding method used in step 204 requires it. The coding step 206 comprises the determination of a prediction block for each block of the rest of the image to be coded. For example, the prediction block is determined from a block spatially neighbouring the block to be coded (mode INTRA), for example by linear combination of such blocks or of certain pixels of such blocks or of blocks of other images (mode INTER). The prediction block is then extracted from the block to be coded, for example by subtraction pixel by pixel with or without weighting. The residue block thus obtained is transformed for example by a DCT (Discrete Cosine Transform) then quantized with a quantization step QPmax>QPmin into a block of coefficients. The transform can be applied successively to several sub-blocks of the residue block. This is notably the case if the residue block is of size 16×16 and if the DCT transform is an 8×8 transform. This coding step does not require the implementation of an entropy coding step.

During a step 208, the rest of the image is decoded. Each block of the rest of the image is decoded in the case where a coding method per block was used in step 206. For this purpose, for each block to be decoded, an inverse quantization then an inverse transform, for example an IDCT (Inverse Discrete Cosine Transform) is applied to the corresponding block of coefficients obtained in step 206, to obtain a decoded residue block. This decoded residue block is then merged with the prediction block, for example by addition pixel by pixel with or without weighting. This decoding step does not require the implementation of an entropy decoding step except if the coding step 206 itself comprises the entropy coding of blocks of coefficients.

During a step 209 the texture of regions of the rest of the image is refined by exploiting the SRi texture at the quality Q0. The refinement step 209 is described in connection to the decoding method (step 16). This refinement step 209 uses the information from data encoded at the quality Q0 in order to enrich the areas encoded at quality Q1 (Q1<Q0). To do this several refinement algorithms are possible.

An example of a refinement algorithm of a current sub-region by an SRi operates in the transform domain, for example on the DCT coefficients. For this purpose, the high frequencies present in the SRi but destroyed in the current sub-region by the quantization during the encoding are added to the current sub-region. For each block b of size a² of the rest of the image, are calculated:

$$\{ \begin{matrix}∀ i ∈ [ 0 , K ] , {DCT}_{merged} ( i ) = {DCT}_{QP max} ( i ) \\ ∀ i ∈ ] K , last\_coef ] , {DCT}_{merged} ( i ) = {DCT}_{{QP}_{max}} ( i ) + α \cdot ( \begin{matrix}{DCT}_{{QP}_{min}} ( i ) - \\ {DCT}_{{QP}_{max}} ( i )\end{matrix} )\end{matrix}$$

where last_coef is the index of the last DCT coefficient of the block, DCT(n) represents the DCT coefficient of the block b at the position n in zigzag order, i.e. the scanning order of the block. DCT_{merged}(n) represents the DCT coefficient of the index n of the refined block, DCT_{QPmin}(n) represents the DCT of index n of the corresponding block of the RSRi and DCT_{QPmax}(n) represents the DCT coefficient of index n of the block b of the current sub-region to be refined.

α and K are two degrees of freedom with:
α: the weight of information added: α={0.1; 0.2; . . . ; 1}
K is an integer that indicates the first DCT coefficient to be merged, K ∈ [0; a²−1].

During a step 210 a metric Di is calculated between the refined image and its reference version, i.e. the source image. According to a variant, the metric Di is calculated between SRi decoded at Q0 and the rest of the refined image, i.e. the other refined sub-regions. The metric in question is for example the mutual information in the mathematical sense of the term or a distortion such as a SAD (Sum of Absolute Differences) or an SSE (Sum of Squared Differences). The Mutual Information represents a form of conditional entropy calculation. According to another variant, the metric is a measurement of the phase correlation.

If for the totality of the regions SRi of the set {SRᵢ}_{i∈{0;M-1}} a metric Di was calculated according to steps 202 to 210 then the method continues to step 212, if not the method repeats the step 202 with an index i incremented by 1.

During a step 212, one keeps as sub-region RSR, i.e. one extracts from the set {SRᵢ}_{i∈{0;M-1}} of M possible sub-regions, the sub-region SRj that has a maximum metric value Dj in the case where the metric is mutual information or the phase correlation (respectively minimum in the case where the metric is a distortion) or the N sub-regions SRj that have the highest metric values in the case where the metric is mutual information or the phase correlation (respectively the lowest in the case where the metric is a distortion).

According to a variant of this embodiment, the step 202, comprises the quantization with a quantization step QPmin of the region SRi.

The step 204 comprises the inverse quantization of the region SRi.

Step 206 comprises the quantization of the rest of the image with a quantization step QPmax>QPmin. In fact, the rest of the image is quantized more superficially, i.e. coded at a lower quality.

Step 208 comprises the inverse quantization of the rest of the image.

The other steps are identical to those of the first variant of this second embodiment.

According to an advantageous embodiment of step 10, the image I to be coded is divided into regions. A single sub-region RSR is extracted from the image I per region, i.e. the dictionary comprises a single sub-region RSR per region. A region is for example a quadrant of the image.

In the specific case of method for coding in accordance with a video coding standard such as MPEG-2, H.264 based on a coding by macroblocks (block of size 16×16) and by blocks (of size 8×8 or 4×4), the RSR sub-regions are macroblocks and the texture refinement is operated by blocks.

Back to FIG. 1, during a step 12, the texture, i.e. the luminance/chrominance values, of the RSR sub-regions, the texture of the rest of the image and possibly a Quality Map (QM) specifying the position of RSR sub-regions are coded in a stream F. During the coding of the texture, the quality map QM is used in order to determine the quality Q0 or Q1 (Q1<Q0) at which the different regions of the image are coded. The sub-regions RSR are coded at a quality Q0 higher to that of Q1 of the rest of the image.

As a non-limiting example, a method for coding per block is used. Each block of the image is coded successively according to a raster scan of the image.

For a current block to be coded, a prediction block is determined. For example, the prediction block is determined from neighbouring blocks of the current block previously coded and decoded (mode INTRA) for example by linear combination of such blocks or of some pixels of such blocks. According to a variant, the prediction block is determined from an image previously decoded and a motion vector (mode INTER), possibly by interpolation notably in the case where the coordinates of the motion vector are not integers. The motion vector comes from a motion estimation, for example of block matching type. The prediction block is then extracted from the current block, for example by subtraction pixel by pixel with or without weighting. The residue block thus obtained is transformed for example by a DCT (Discrete Cosine Transform) then quantized into a block of coefficients. The transformed residue block is quantized with a quantization step that depends on the quality Q0 or Q1 at which it must be coded, information that is provided by the quality map. If the current block is an RSR sub-region then it is quantized with a QPmin step if not it is quantized with a QPmax>QPmin step. The block of coefficients and possibly the motion vector are coded by entropy coding of VLC (Variable Length Coding) or CABAC type.

The quality map is, for example, coded using an SEI (Supplemental Enhancement Information) message or more usually in a field reserved for user data.

In the specific case of method for coding in accordance with a video coding standard such as MPEG-2, H.264 based on a coding by macroblocks (blocks of size 16×16) and by blocks (of size 8×8 or 4×4), the RSR sub-regions are macroblocks. Thus the quality map enables the quantization steps (QPs) of RSR or non RSR macroblocks to be adapted. QPmax a quantization step higher than that of QPmin used to quantize the RSR sub-regions is used to quantize the non RSR sub-regions. This enables the respective qualities Q0 and Q1 to be obtained. In this frame, the quality map does not need to be coded explicitly in the stream F as the quantization steps are coded in the stream. Hence, during the decoding method, the value of the quantization step decoded for a block is representative of its RSR sub-region or non RSR sub-region quality. In fact, if the quantization step decoded for a block is QPmax then this block is necessarily a non RSR sub-region while if the quantization step decoded for a block is QPmin then this bloc is necessarily an RSR sub-region.

The method for decoding is described in relation to FIG. 1.

During a step 14, the texture of RSR sub-regions and non RSR sub-regions is decoded. For example, a method for decoding in accordance with the standard H.264 is used if the corresponding method for coding was used in step 12. Without being restrictive, a method for decoding per block is used. Each block of the image is decoded successively according to a raster scan of the image.

For a current block to be decoded, a prediction block is determined. For example, the prediction block is determined from neighbouring blocks of the current block previously decoded (mode INTRA) for example by linear combination of such blocks or of some pixels of such blocks. According to a variant, the prediction block is determined from an image and a motion vector previously decoded (mode INTER), possibly by interpolation notably in the case where the coordinates of the motion vector are not integers. For the current block, a residue block is decoded from the stream F by VLC (Variable Length Coding) or CABAC type entropy decoding. The prediction block is then merged with the decoded residue block, for example by addition pixel by pixel with or without weighting. An inverse quantization then an inverse transform is applied on the merged block for example via an IDCT (Inverse Discrete Cosine Transform). The quantization step used by the inverse quantization depends on the quality Q0 or Q1 at which the current block was coded in step 12. If the current block is an RSR sub-region then it is dequantized with a QPmin step if not it is dequantized with a QPmax>QPmin step. The quantization step being generally coded in the stream, it is not necessary to decode a quality map. However according to a variant, if no quantization step is coded in the stream F then the quality map is decoded.

During a step 16, the texture of non RSR sub-regions is refined. This step comprises the use of the information from data coded at the quality Q0 (i.e. the RSR sub-regions) in order to enrich the areas coded at the quality Q1 (Q1<Q0). To do this several refinement algorithms are possible.

An example of a refinement algorithm of a current sub-region by an RSRi sub-region operates in the transform domain, for example on the DCT coefficients. For this purpose, the high frequencies present in the RSRi but destroyed in the current sub-region by the quantization during the encoding are added to the current sub-region. For each block b of size a², for example a=8 if the DCT is an 8×8 DCT, of the current sub-region, are calculated:

$$\{ \begin{matrix}∀ i ∈ [ 0 , K ] , {DCT}_{merged} ( i ) = {DCT}_{QP max} ( i ) \\ ∀ i ∈ ] K , last\_coef ] , {DCT}_{merged} ( i ) = {DCT}_{{QP}_{max}} ( i ) + α \cdot ( \begin{matrix}{DCT}_{{QP}_{min}} ( i ) - \\ {DCT}_{{QP}_{max}} ( i )\end{matrix} )\end{matrix}$$

where last_coef is the index of the last DCT coefficient of the block, DCT(n) represents the DCT coefficient of the block b at the position n in zigzag order, i.e. the scanning order of the block. DCT_{merged}(n) represents the DCT coefficient of the index n of the refined block, DCTₘᵢₙ(n) represents the DCT coefficient of index n of the corresponding block of the RSRi and DCTₘₐₓ(n) represents the DCT coefficient of index n of the block b of the current sub-region to be refined. The RSRi used to refine the current sub-region is selected in the “dictionary” as being for example the closest spatially to the current sub-region to be refined or that which is the most correlated with the current sub-region to be refined. According to another variant, the image to be decoded is divided into regions and the dictionary comprises a single sub-region RSRi per region. In this case, a current sub-region is refined using the RSRi of the dictionary that belongs to the same region of the image. A region is for example a quadrant of the image.

α and K are two degrees of freedom with:
α: the weight of information added: α={0.1; 0.2; . . . ; 1}
K: the first DCT coefficient to be merged. K ∈ [0;a²−1]

Other approaches can be used in this refinement step 16. Thus are cited the “guided texture synthesis” algorithms described in the document by Ashikhmin entitled Synthesizing natural textures and published in the proceedings of the ACM Symposium on Interactive 3D Graphics. In this case, the RSi serve as the dictionary and the low quality version Q1 of the current region to be refined, serves as guide.

Other iterative more developed texture synthesis approaches can also use the low quality version Q1 as initial iteration and thus be refined by use of RSi as described in the document by Kwatra et al. entitled Texture optimization for example-based synthesis and published in 2005 in the ACM Symposium on Interactive 3D Graphics, (2005).

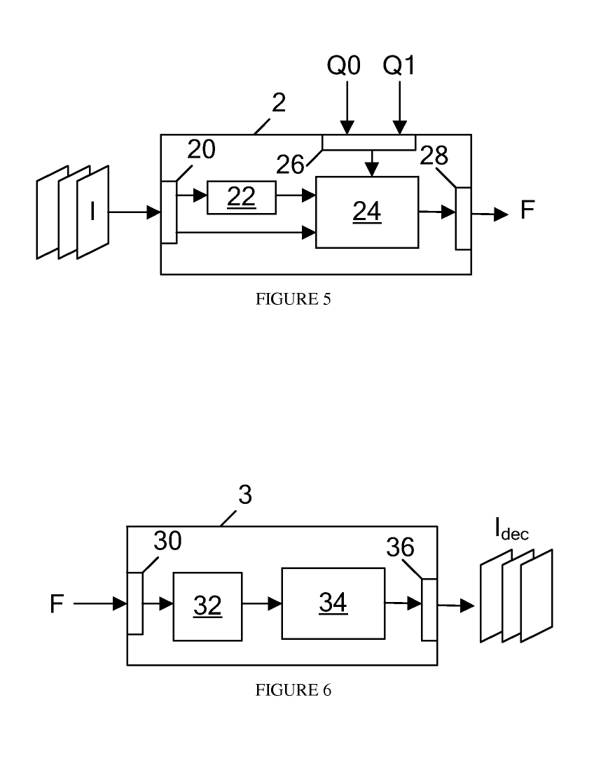

In reference to FIG. 5, the invention relates to a coding device 2. The coding device 2 receives in a first input 20 images I and in a second input 26 quality values Q0 and Q1, where Q0>Q1.

The coding device 2 comprises an extraction module 22 able to extract images I of RSR sub-regions in accordance with step 12 of the coding method. More specifically the extraction module 22 implements the steps 92 to 94 or 100 to 112 or 200 to 212 of the coding method.

It also comprises a coding module 24 able to code the RSR sub-regions extracted by the extraction module 22 at the quality Q0 and the other non RSR sub-regions at the quality Q1 in a stream F. The stream F is transmitted via an output 28.

In reference to FIG. 6, the invention relates to a decoding device 3. The decoding device receives at an input 30 a stream F from for example a coding device 2. The decoding device 3 comprises a decoding module 32 able to decode images I. More specifically the decoding device 3 decodes on the one hand the RSR sub-regions at the quality Q0 and on the other hand the non RSR sub-regions at the quality Q1 either using a quality map itself decoded from the stream F or using directly quantization steps Qmin and Qmax decoded from the stream F. The decoding module 32 is able to implement step 14 of the decoding method.

The decoding device 3 comprises a refinement module 34. The refinement module is able to refine the texture of non RSR sub-regions decoded by the decoding module 32 with the texture of RSR sub-regions decoded by the decoding module 32 able to implement step 16 of the decoding method. The images I_{dec} thus decoded are transmitted via an output 36.

Naturally, the invention is not limited to the embodiment examples mentioned above.

In particular, those skilled in the art may apply any variant to the stated embodiments and combine them to benefit from their various advantages. Notably the steps of coding 12 and the decoding 14 can be in accordance with the standard H.264 or MPEG-2 but also with JPEG or with any other type of standard. The invention applies to the coding of a still image or to the coding of a sequence of images.

The metric Di is also calculated in different ways. Di is for example a PSNR (Peak to Signal Noise Ratio) value or a metric of objective texture quality such as for example the SSIM (Structural SIMilarity) or a phase correlation, an item of mutual information, a SAD or an SSE.

1. Method for coding a source image divided into sub-regions comprising the following steps:
extracting from said source image sub-regions representative of other sub-regions of the source image,
coding said sub-regions representative of other sub-regions at a first quality and
the other sub-regions at a second quality strictly lower than said first quality,
wherein the step of extraction of sub-regions representative of other sub-regions of the source image comprises the following steps, for each sub-region of the source image, called current sub-region:
coding said current sub-region at said first quality,
decoding said current sub-region into a decoded current sub-region,
coding the other sub-regions different to said current sub-region at said second quality,
decoding said other sub-regions into decoded sub-regions, and
calculating a metric between said decoded current sub-region and said other decoded sub-regions,
and wherein the extraction step comprises the extraction from said source image of N sub-regions for which the metric is highest or N sub-regions for which the metric is lowest, where N is an integer.

2. Method for coding according to claim 1, which further comprises a step of coding a quality map wherein said quality map associates with each sub-region of the source image a coding quality among said first quality and said second quality.

3. Method for coding according to claim 1, wherein the extraction step of sub-regions representative of other sub-regions of the source image also comprises a step of refinement of the texture of said other decoded sub-regions by using the texture of said decoded current sub-region and in which said metric is calculated between said decoded current sub-region and said other refined sub-regions.

4. Method for coding according to claim 1, wherein the extraction step of sub-regions representative of other sub-regions of the source image also comprises a step of refinement of the texture of said other decoded sub-regions by using the texture of said decoded current sub-region and in which said metric is calculated between a refined image comprising said other refined sub-regions and said source image.

5. Method for coding according to claim 1, wherein said metric is mutual information and in which the step of extraction comprises the extraction from said source image of N sub-regions for which the metric is highest.

6. Method for coding according to claim 1, wherein said metric is a distortion and in which the step of extraction comprises the extraction from said source image of N sub-regions for which the metric is lowest.

7. Method for coding according to claim 3, wherein said step of refinement comprises, the replacement, in a frequency domain, of each coefficient corresponding to one of the K highest frequencies of one of the other decoded sub-regions by a linear combination of said coefficient of said other decoded sub-region and a coefficient corresponding to said decoded current sub-region.

8. Method for decoding at least one source image divided into first and second sub-regions, said first sub-regions being representative of said second sub-regions comprising a step of decoding first and second sub-regions, a step of refinement of the texture of said second sub-regions from the texture of said first sub-regions and wherein said step of refinement comprises, the replacement, in a frequency domain, of each coefficient corresponding to one of the K highest frequencies of a second sub-region by a linear combination of said coefficient of said second sub region and a coefficient corresponding to said first sub-region.

9. Method according to claim 1 wherein, N is superior to 1.

10. Device for coding a source image divided into sub-regions comprising:
an extraction module for extracting from said source image sub-regions representative of other sub-regions of the source image,
a coding module for coding said sub-regions representative of other sub-regions at a first quality and the other sub-regions at a second quality strictly lower than said first quality, wherein the extraction module comprises:
a coding module for coding a current sub-region at said first quality and the other sub-regions different to said current sub-region at said second quality,
a decoding module for decoding said current sub-region into a decoded current sub-region and said other sub-regions into decoded sub-regions, and
a calculating module for calculating a metric between said decoded current sub-region and said other decoded sub-regions,
and wherein the extraction module is configured to extract from said source image N sub-regions for which the metric is highest or N sub-regions for which the metric is lowest, where N is an integer.

11. Device for decoding at least one source image divided into first and second sub-regions, said first sub-regions being representative of said second sub-regions comprising a decoding module for decoding first and second sub-regions, a refinement module for refining the texture of said second sub-regions from the texture of said first sub-regions and wherein said refinement module is configured to replace in a frequency domain, of each coefficient corresponding to one of the K highest frequencies of a second sub-region by a linear combination of said coefficient of said second sub region and a coefficient corresponding to said first sub-region.
